(19) United States
(12) Patent Application Publication
(10) Pub. No.: US 2009/0271939 A1
(43) Pub. Date: Nov. 5, 2009

(54) WINDSCREEN WIPING DEVICE, PARTICULARLY FOR A MOTOR VEHICLE

(75) Inventors: Andreas Benner, Buehlertal (DE); Rainer Hummel, Rheinau (DE); Jose Carlos Pino Joaquin, Arbos del Penedes (ES); Jan Dietrich, Buehl (DE); Gundolf Surkamp, Vilafranca Del Penedes Barcel (ES); Achim Kraus, Buehl (DE); Hermann Burkard, Iffezheim (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,248

(22) PCT Filed: Nov. 16, 2007
(86) PCT No.: PCT/EP2007/062441

§ 371 Date: Dec. 17, 2008

(30) Foreign Application Priority Data
Dec. 12, 2006 (DE) 10 2006 058 740.5

(51) Int. Cl. B60S 1/06

(52) U.S. Cl. 15/250.31

(57) ABSTRACT

The invention relates to a windscreen wiping device (10), particularly for a motor vehicle, having a support (12) which is particularly constructed in a substantially tubular shape. A drive unit (34) with a housing (36) is arranged on the support (12), said housing having a holder (38). According to the invention, the support (12) has a section (42) which is substantially H-shaped in cross section for fastening to the holder (38).

### BACKGROUND OF THE INVENTION

The invention relates to a windscreen wiping device, particularly for a motor vehicle.

Numerous windscreen wiping devices for motor vehicles are known, which have a substantially tubular carrier, to which a drive unit is fixed by a holder, which is formed on a housing of the drive unit. The provision of a separate holder, such as a fixing plate, to which the drive unit is fixed, on the carrier is also known.

U.S. Pat. No. 6,343,403, for example, discloses a windscreen wiping device, in which a tubular carrier is pressed in its middle section to form a U-shaped cross sectional profile. The drive unit here is arranged in a housing, which has a holder, which is fixed in this bent, U-shaped cross sectional area.

### SUMMARY OF THE INVENTION

The windscreen wiping device has the advantage that the carrier, for fixing to the holder, has at least one section of substantially H-shaped cross section.

This results in a more stable and torsionally stiffer windscreen wiping device, which is also substantially less expensive and easier to produce.

The measures cited in the dependent claims result in advantageous developments and improvements of the features specified in the main claim.

It is especially advantageous if the H-shaped section has lateral members and a central section connecting the lateral members, which internally is at least partly hollow. This results in a substantially greater stability and rigidity of the carrier and thereby the entire windscreen wiping device.

Furthermore the stability of the windscreen wiping device can advantageously be increased in that the H-shaped section has lateral members and a central section connecting the lateral members and that at least one of the lateral members is internally at least partly hollow.

It is moreover advantageous if a fastener is provided for fixing the carrier to the holder, said fastener being formed by a self-tapping, threaded screw.

In an especially advantageous development the holder has a seat for the fastener in the area of the H-shaped section, the carrier having a recess, which is formed or arranged to complement the recess in the holder.

In a variant the fasteners are advantageously formed by blind rivets.

A very high degree of stability results from embodying the holder as a fixing dome and mounting the carrier in the area of its H-shaped section on the holder.

An especially easy assembly of the windscreen wiping device is achieved in that the holder has at least one pin, which for positioning the windscreen wiper motor in relation to the carrier engages in at least a second complementary recess formed on the carrier.

### BRIEF DESCRIPTION OF THE DRAWINGS

An exemplary embodiment of the invention is represented in the drawings and is explained in more detail in the following description.

In the drawing:

FIG. 1 shows a schematic representation of a windscreen wiping device according to the invention,

FIG. 2 shows a cross section through the carrier of the windscreen wiping device,

FIGS. 3 to 6 show cross sections through a carrier of the windscreen wiping device in different variants.

### DETAILED DESCRIPTION

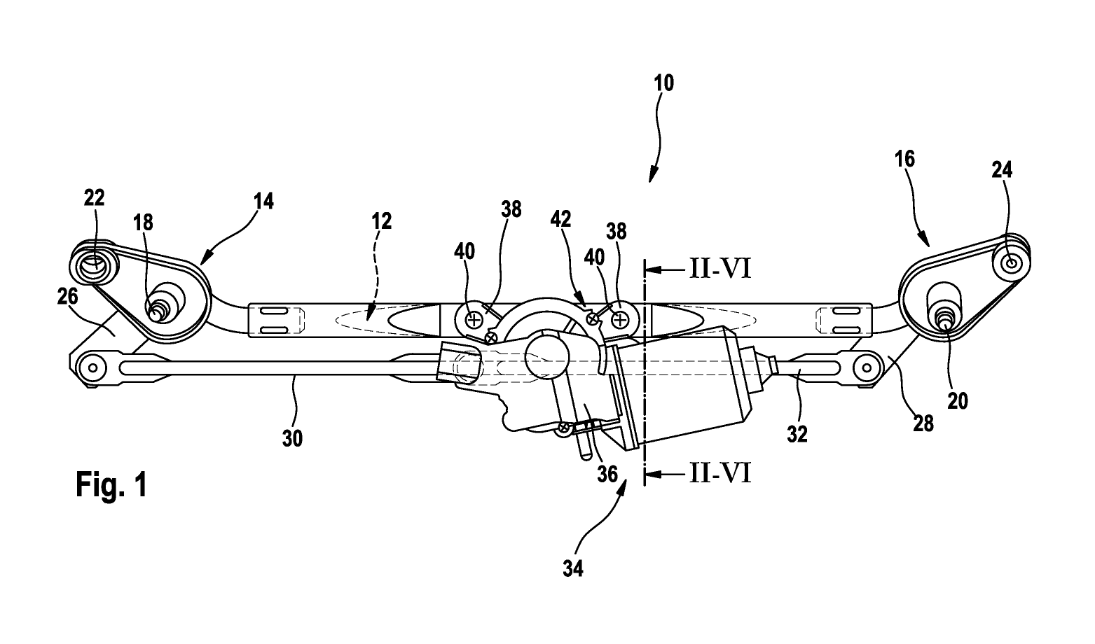

FIG. 1 shows a schematic representation of a windscreen wiping device 10.

This basically comprises a carrier 12, which is of tubular design. Besides the circular cross section shown here the tube may naturally also have a square, rectangular or elliptical cross section. In principle, however, a profiled carrier is also possible instead of a tube.

A windscreen wiper bearing 14, 16 is fixed to each of the longitudinal ends of the carrier 12, in each of which bearings a wiper shaft 18, 20 is supported. The windscreen wiper bearings 14, 16 are fixed to the carrier 12 by force closure, positive interlock or material fusion, being crimped, welded, screwed or riveted on, for example. A snap or clipped connection is also feasible here.

A fixing section 22, 24, which serves for fixing the windscreen wiping device 10 to a motor vehicle, is also provided on the windscreen wiper bearings 14, 16. The wiper shafts 18, 20 are each driven via a drive crank 26, 28, which is rotationally fixed to the respective wiper shaft 18, 20. In order for the wiper shafts 18, 20 to perform an oscillating movement, a push rod 30, 32, the end of which remote from the crank 26, 28 is connected to a driven crank of a drive unit 34, is in each case articulated at the free end of the respective drive crank 26, 28. When the driven crank of the drive unit 34 performs a circular or oscillating movement, the drive cranks 26, 28 are set in oscillating motion by the push rods 30, 32. The drive unit 34 is here embodied as an electric motor, which incorporates a worm gear. The drive unit 34 is enclosed by a housing 36, which has a holder 38, which serves for fixing the drive unit 34 to the carrier 12. The holders 38 are here of domed design. These may each have a seat to accommodate fasteners 40. Self tapping threaded screws, blind rivets or clips may serve here as fasteners 40. The holder 38 is here fixed to the carrier 12 in the central area relative to the longitudinal extent of the carrier 12, that is to say between the windscreen wiper bearings 14, 16. For this purpose the tubular carrier 12 is constricted to give it an H-shaped profile in the area of the holder 38, so that the carrier 12 has an H-shaped section 42.

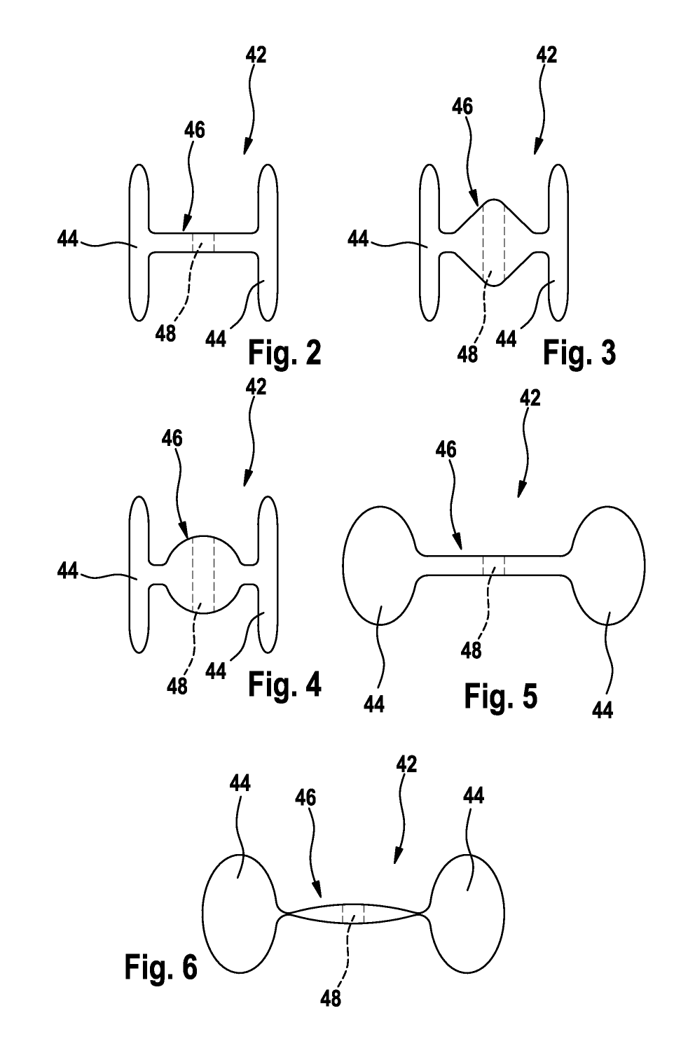

FIG. 2 shows a cross section through the H-shaped section 42 of the carrier 12. The H-shaped section here has two lateral members 44, which are connected to one another by a central section 46 approximately in the middle of their longitudinal extent. If the carrier 12 is made from a sheet metal tube of thickness D, this gives a thickness of about 2 sheet metal layers and hence a thickness of 2D for the lateral members 44 and the central section 46. Approximately in the middle between the two lateral members 44, the central section 46 has a recess 48, which takes the form of a circular hole, for example. The recess 48 here serves for interaction with the fastener 40, so that the H-shaped section 42 and hence the carrier 12 can be connected to the holder 38 of the housing 36.

FIG. 3 shows a variation of the substantially H-shaped section 42 of a windscreen wiping device 10. The two lateral members 44 are formed as in FIG. 2. However, the central section 46 here is of rhombic design, so that the central section 46 is internally hollow. The recess 48 as seat for the fastener is here formed by a hole which runs approximately through the two corners of the central section 46 of rhombic cross section remote from the lateral members 44. In a variation, however, the hole may also run through the two substantially parallel faces of the rhombic central section 46, that is to say, therefore, obliquely.

FIG. 4 shows a further variation of the H-shaped section 42. The two lateral members 44 are here formed in the same way as in FIGS. 2 and 3. However, the central section 46 here is bent to a shape substantially circular in cross section, resulting in an internal hollow cavity. The recess 48 is represented by two holes on the side walls, which lie between the lateral members 44. An opening, through which the fastener 40 can be threaded substantially parallel to the lateral members 44, thereby results on both sides of the central section 46.

FIG. 5 shows a further variation of the section 42. Here the H-shaped section 42 is substantially bone-shaped. The two lateral members 44 are substantially circular and internally hollow. The two lateral members 44 are connected by the central section 46, which internally, however, is not entirely filled. A cavity is thereby produced, which links the cavities in the lateral members 44 together. For seating of the fastener, two holes are here again provided in the central section 46 as recesses 48, through which the fastener 40 can be threaded.

FIG. 6 shows yet a further variation of the H-shaped section 42 in cross section. As in the example shown in FIG. 5, the two lateral members 44 are here likewise internally hollow, so that here again a bone shape basically results. The central section 46 is of hollow design in the area between the two lateral members 44, but the connecting areas between the central section 46 and the respective lateral member 44 are constricted in such a way that there is no cavity at this point. For seating of the fastener 40, recesses 48 are here again provided, which take the form of holes in the central section 46.

Common to all of these exemplary embodiments in FIG. 2 to FIG. 6 is the fact that in cross section these are mirror-symmetrical with regard to the lateral members 44 and the central section 46. The recess 48 for seating of the fastener 40 is at the same time arranged substantially centrally between the two lateral members 44 and passes through the full length of the central section 46. The fastener can here in each case be seated parallel to the lateral members 44.

The exemplary embodiments in FIGS. 5 and 6, which shown a substantially bone-shaped cross sectional formation of the section 42, are not limited to a circular cross-sectional shape of the lateral members 44. Instead the lateral members 44 may also be of elliptical design. It is furthermore also possible to dispense entirely with the symmetry between the two lateral members 44, and to provide only one lateral member 44.

Furthermore, a second recess, which does not pass right through the central section 46, may also be provided in the central section 46. This second recess is then arranged so that it is capable of receiving a pin, which is arranged on the holder 38 of the windscreen wiping device 10, so that the H-shaped section 40 of the carrier 12 can be positioned more easily and more precisely during assembly. This thereby constitutes a positioning aid, which substantially facilitates the assembly of the windscreen wiping device 10.

1. A windscreen wiping device (10), having a carrier (12), which is in particular of a substantially tubular design, a drive unit (34) and a holder (38), which is formed on a housing (36) of the drive unit (34), characterized in that the carrier (12) has at least one section (42) of substantially H-shaped cross section for fixing to the holder (38).

2. The windscreen wiping device (10) as claimed in claim 1, characterized in that the H-shaped section (42) has lateral members (44) and a central section (46) connecting the lateral members (44), and the central section (46) and/or at least one of the lateral members (44) are internally at least partly hollow.

3. The windscreen wiping device (10) as claimed in claim 1, characterized in that at least one fastener (40) is provided for fixing the carrier (12) to the holder (38), said fastener being formed by a self-tapping, threaded screw.

4. The windscreen wiping device (10) as claimed in claim 1, characterized in that the holder (38) comprises at least one seat for the fastener (40) in the area of the H-shaped section (42), the carrier (12) having at least one recess (48), which is formed to complement at least one in the holder (38).

5. The windscreen wiping device (10) as claimed in claim 4, characterized in that at least one fastener (4) is formed by a blind rivet.

6. The windscreen wiping device (10) as claimed in claim 1, characterized in that the holder (38) is embodied as a fixing dome and the carrier (12) in the area of its H-shaped section (42) can be mounted on the holder (38).

7. The windscreen wiping device (10) as claimed in claim 1, characterized in that the holder (38) has at least one pin, which for positioning the drive unit (34) in relation to the carrier (12) engages in at least a second complementary recess formed on the carrier (12).

8. The windscreen wiping device (10) as claimed in claim 2, characterized in that at least one fastener (40) is provided for fixing the carrier (12) to the holder (38), said fastener being formed by a self-tapping, threaded screw.

9. The windscreen wiping device (10) as claimed in claim 8, characterized in that the holder (38) comprises at least one seat for the fastener (40) in the area of the H-shaped section (42), the carrier (12) having at least one recess (48), which is formed to complement at least one in the holder (38).

10. The windscreen wiping device (10) as claimed in claim 9, characterized in that at least one fastener (4) is formed by a blind rivet.

11. The windscreen wiping device (10) as claimed in claim 10, characterized in that the holder (38) is embodied as a fixing dome and the carrier (12) in the area of its H-shaped section (42) can be mounted on the holder (38).

12. The windscreen wiping device (10) as claimed in claim 11, characterized in that the holder (38) has at least one pin, which for positioning the drive unit (34) in relation to the carrier (12) engages in at least a second complementary recess formed on the carrier (12).
